(19) United States
(12) Patent Application Publication
(10) Pub. No.: US 2015/0221913 A1
(43) Pub. Date: Aug. 6, 2015

(54) Device for Increasing Safety when using Battery Systems

(71) Applicants: Robert Bosch GmbH, Stuttgart (DE); Samsung SDI Co., Ltd., Yongin-si (KR)

(72) Inventors: Florian Engel, Munchen (DE); Bernd Siewert, Stuttgart (DE); Markus Hald, Jagstzell (DE); Matthias Oechsle, Ditzingen-Hirschlanden (DE); Rene Deponte, Sersheim (DE); Andreas Eichendorf, Stuttgart (DE); Carsten Mueller, Stuttgart (DE); Oliver Gerundt, Friolzheim (DE)

(21) Appl. No.: 14/612,364

(22) Filed: Feb. 3, 2015

(30) Foreign Application Priority Data
Feb. 5, 2014 (DE) 10 2014 202 043.3

(51) Int. Cl. H01M 2/12

(52) U.S. Cl. CPC H01M 2/1241; H01M 2/1264; H01M 2220/20; H01M 2200/20

(57) ABSTRACT

A battery system, in particular a lithium-ion battery system, includes at least one degassing device that is configured to increase the safety of battery systems. The degassing device enables controlled discharging of substances from battery systems by discharging the substances with a volume flow that is dependent on a pressure prevailing in the interior of the degassing device.

This application claims priority under 35 U.S.C. §119 to patent application no. DE 10 2014 202 043.3, filed on Feb. 5, 2014 in Germany, the disclosure of which is incorporated herein by reference in its entirety.

### BACKGROUND

The present disclosure relates to a battery system and to the use thereof.

Devices for increasing safety when using a degassing system of battery systems are known from the prior art, wherein the degassing system is connected to a battery system by means of a port and is suitable for the controlled degassing of battery systems. In this context, the degassing system is suitable for discharging substances, in particular gases, from possibly damaged battery systems.

### SUMMARY

The disclosure is based on a battery system, in particular a lithium ion battery system, having at least one degassing device for increasing safety when using battery systems, wherein the degassing device is suitable for the controlled discharging of substances from battery systems.

The disclosure relates to a battery system having the features of the disclosure.

The core of the disclosure is that the substances are discharged with a volume flow which is dependent on a pressure prevailing in the interior of the degassing device.

The fact that substances with a volume flow which is dependent on a pressure prevailing in the interior of the degassing device are to be discharged leads to the advantage according to the disclosure that a battery system and/or persons or objects which are located in the surroundings of the battery system are protected against the possible effects which can be caused by the discharged substances. If an excessively high pressure prevails in the interior of the degassing device, reduction in the pressure is advantageous and leads to an increase in the safety in the surroundings with battery systems. Whether a pressure is too high depends, for example, on the cross section of the degassing device. An exemplary pressure which is too high can be between 8 bar and 10 bar or between 20 bar and 30 bar.

The pressure prevailing in the interior of the degassing device depends on the state of the battery system, for example the temperature prevailing in the interior of the battery system and/or a possible state of damage of the battery system.

The background of the disclosure is that the pressure prevailing in the interior of the degassing device can lead to a pressure surge in the interior of the degassing device and from there to a sudden propagation of pressure in the surroundings of the battery system. As a result of the sudden propagation of pressure, persons or objects which are located in the surroundings of the battery system can be damaged. The fact that substances with a volume flow dependent on a pressure prevailing in the interior of the degassing device are discharged leads to a situation in which the pressure surge can be weakened. The weakening of the pressure surge gives rise to a reduction in the probability of damaging persons or objects which are located in the surroundings of the battery system. The weakening of the pressure surge leads in turn to lower loading of components of the battery system.

According to the disclosure, the at least one degassing device is a rupture disk or an overpressure valve or a degassing line.

Further advantageous embodiments of the present disclosure are subject matters of the dependent claims.

According to a subsequent advantageous embodiment of the disclosure, the rupture disk has various regions and the regions have various thicknesses.

The various thicknesses of the various regions extend, for example, from 0.1*10⁻³ m to 0.5*10⁻³ m.

As a result of the various thicknesses of the regions, an opening surface which forms as a function of the applied pressure becomes larger in stages. As a result of the fact that the pressure leads to an incremental increase in the opening surface, the pressure within the battery system is reduced incrementally.

According to a subsequent advantageous embodiment of the disclosure, the degassing device has a throttle.

In accordance with a further preferred embodiment of the disclosure, the degassing device has a sound damper. In this context, the sound damper contains, in particular, a porous material, preferably a sintered metal, for example sintered bronze, or a metal mesh or a plastic or a ceramic.

As a result of the preferred embodiment according to which the degassing device has a throttle or a sound damper, the resistance to be flowed through is opposed to the out-flowing substances. This resistance to be flowed through gives rise to a reduction in the flow speed. The reduction in the flow speed results in a reduction in the loading of components of the battery system or of persons or objects in the surroundings of the battery system which are subjected to the out-flowing substances.

According to a subsequent advantageous embodiment of the disclosure, the degassing device has a multi-stage rupture diaphragm. The multi-stage rupture diaphragm is composed of individual rupture diaphragms. In this context, the individual rupture diaphragms are activated and penetrated at different pressures in the interior of the degassing device.

The fact that the degassing device has a multi-stage rupture diaphragm gives rise to the advantage according to the disclosure that pressure peaks which possibly occur are compensated. The compensation is caused by incremental activation and penetration of the individual rupture diaphragms. In this context, for example initially a low pressure can give rise to activation and penetration of a first individual rupture diaphragm, and then a pressure which becomes higher in comparison with this low pressure gives rise to activation and penetration of a second individual rupture diaphragm. This incremental activation and penetration of the individual rupture diaphragms causes a pressure which is reaching its maximum value to be reduced in that the discharging of the substances is already initiated before the maximum pressure is reached.

In accordance with a subsequent preferred embodiment of the disclosure, the degassing device has a diaphragm, wherein the diaphragm is suitable for rupturing under pressure, and the diaphragm has various regions. In this context, the various regions of the diaphragm are located at the same level in the direction of a flow vector of the discharged substance, and the regions have various thicknesses.

According to a further advantageous embodiment of the disclosure, a throttle is arranged downstream of a rupture disk or downstream of an overpressure valve in the direction of a flow vector of the discharged substance. The flow vector of the discharged substance is a vector which points in a direction in which the greater part of the substance to be discharged flows in the degassing system.

According to a further preferred embodiment of the disclosure, a throttle is inserted into a rupture disk or into an overpressure valve.

As a result of the insertion of the throttle into the rupture disk or into the overpressure valve, it is possible to influence a possibly occurring supersonic flow of the discharged substance. The supersonic flow of the discharged substance depends, inter alia, on the cross-section of the degassing device.

According to a further advantageous embodiment of the disclosure, a sound damper is arranged downstream of a rupture disk or downstream of an overpressure valve in the direction of a flow vector of the discharged substance.

The arrangement of the sound damper downstream of the rupture disk or downstream of the overpressure valve in the direction of the flow vector of the discharged substance gives rise to the advantage according to the disclosure that noise which is produced by the substances flowing out downstream of the rupture disk or downstream of the overpressure valve is attenuated. The attenuation of noise serves, in particular, to protect persons in the surroundings of the battery system.

According to a subsequent advantageous embodiment of the disclosure, the sound damper is inserted into a rupture disk or into an overpressure valve.

As a result of the insertion of the sound damper into the rupture disk or into the overpressure valve, it is possible to influence possibly occurring supersonic flow of the discharged substance. The supersonic flow of the discharged substance depends, inter alia, on the cross section of the degassing device.

According to a further advantageous embodiment of the disclosure, a multi-stage rupture diaphragm is arranged downstream of a rupture disk or downstream of an overpressure valve in the direction of a flow vector of the discharged substance.

The arrangement of the multi-stage rupture diaphragm in the direction of the flow vector downstream of the rupture disk or downstream of the overpressure valve in the direction of the flow vector of the discharged substance gives rise to the advantage according to the disclosure that components of the battery system which are arranged downstream of the rupture disk or downstream of the overpressure valve are protected against the discharged substances.

According to a subsequent advantageous embodiment of the disclosure, a multi-stage rupture diaphragm is inserted into a rupture disk or into an overpressure valve.

As a result of the insertion of the multi-stage rupture diaphragm into the rupture disk or into the overpressure valve, it is possible to influence a possibly occurring supersonic flow of the discharged substance. The supersonic flow of the discharged substance depends, inter alia, on the cross section of the degassing device.

According to a further advantageous embodiment of the disclosure, a diaphragm is arranged downstream of a rupture disk or downstream of an overpressure valve in the direction of a flow vector of the discharged substance.

The arrangement of the diaphragm downstream of the rupture disk or downstream of the overpressure valve in the direction of the flow vector of the discharged substance gives rise to the advantage according to the disclosure that components of the battery system which are arranged downstream of the rupture disks or downstream of the overpressure valve are protected from the discharged substances.

According to a further preferred embodiment of the disclosure, a diaphragm is inserted into a rupture disk or into an overpressure valve.

As a result of the insertion of the diaphragm into the rupture disk or into the pressure valve, it is possible to influence a possibly occurring supersonic flow of the discharged substance. The supersonic flow of the discharged substance depends, inter alia, on the cross section of the degassing device.

According to a further preferred configuration of the disclosure, the battery system is used in a vehicle, in particular in a motor vehicle.

### BRIEF DESCRIPTION OF THE DRAWINGS

The disclosure is explained in more detail below on the basis of exemplary embodiments from which further inventive features arise, but the disclosure is not restricted in its scope to said features. The exemplary embodiments are illustrated in the figures, of which:

FIG. 1 shows a schematic illustration of a battery system according to the disclosure having at least one degassing device for increasing safety when using battery systems;

FIGS. 2a-d show a schematic illustration of four variants of a multi-stage rupture diaphragm, in particular of a multi-stage rupture diaphragm of a degassing device according to FIG. 1, for increasing safety when using battery systems;

FIG. 3 shows a schematic illustration of a method for regulating a volume flow;

FIGS. 4 and 4a show a schematic illustration of a battery system according to the disclosure with a diaphragm, wherein the diaphragm is suitable for rupture under pressure, and the diaphragm has various regions which are located at the same level in parallel in the direction of a flow vector of the discharged substance, and the regions have various thicknesses;

FIGS. 5 and 5a show a schematic illustration of a battery system according to the disclosure with a throttle according to a first exemplary embodiment; and

FIGS. 6a and 6b show a schematic illustration of a battery system according to the disclosure with a throttle according to a second exemplary embodiment.

### DETAILED DESCRIPTION

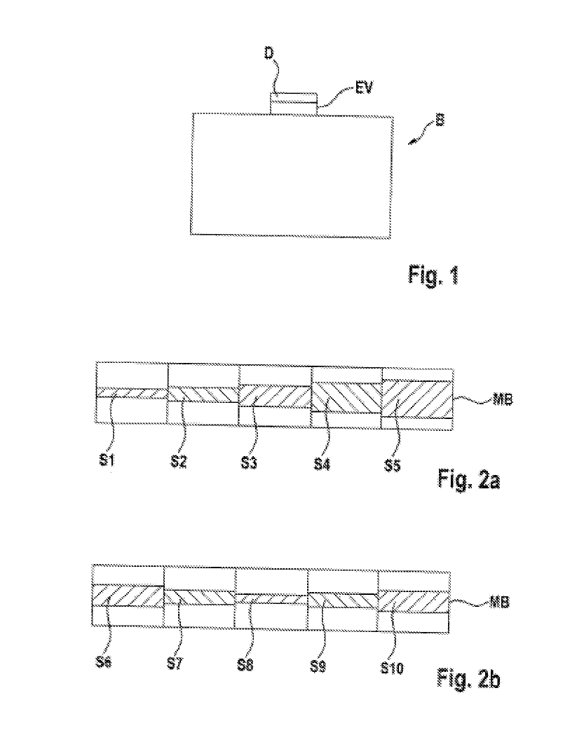

FIG. 1 schematically illustrates a battery system according to the disclosure, in particular a lithium ion battery system, having at least one degassing device for increasing safety when using battery systems. B denotes the battery system. EV denotes the degassing device for increasing safety when using battery systems B. D denotes a device which is suitable for ensuring that substances which are produced in the battery system B are discharged with a volume flow which is dependent on a pressure prevailing in the interior of the degassing device EV.

The degassing device EV can be, in particular, a rupture disk or an overpressure valve or a degassing line. The device D can be a throttle, a sound damper, a multi-stage rupture diaphragm or a diaphragm. In the exemplary embodiment illustrated in FIG. 1, the device D is arranged downstream of the degassing device EV in the direction of a flow vector of the discharged substance.

The device D can, for example, also be arranged upstream of the degassing device EV in the direction of a flow vector of the discharged substance. The arrangement of the device D upstream of the degassing device EV brings about the advantage according to the disclosure of being able to dispense with structural additions to the mechanical support of the device D in the direction of the flow vector downstream of the degassing device EV since according to this exemplary embodiment the device D is supported by the degassing device EV.

The device D can also be inserted, for example, into the degassing device EV. The battery system B according the disclosure can be used, for example, in a vehicle, in particular in a motor vehicle.

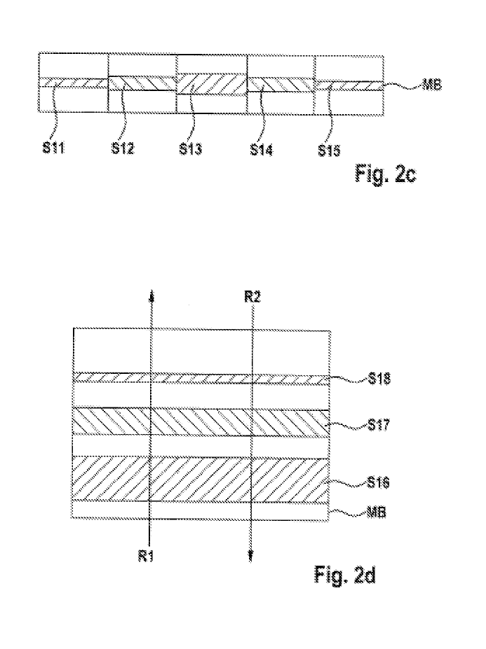

In FIGS. 2a-d, an inventive, multi-stage rupture diaphragm for increasing safety when using a battery system is illustrated schematically in four variants. The multi-stage rupture diaphragm is denoted by MB. The multi-stage rupture diagraph MB has various stages which are activated and penetrated differently and penetrated at pressures, for example by means of various thicknesses, in the interior of a degassing device which is not illustrated in this figure. The individual stages correspond to individual rupture diaphragms.

The various stages are arranged differently depending on the variant and are denoted, according to the exemplary embodiment illustrated in the partial figure, by S1, S2, S3, S4, S5—that is to say in partial FIG. 2a—, by S6, S7, S8, S9, S10—that is to say in partial FIG. 2b—and by S11, S12, S13, S14 and S15—that is to say in partial FIG. 2c.

The stages S1 to S15 can be embodied, for example, coherently or in a spatially separated fashion.

In partial FIG. 2a, the stages S1 to S5 of the multi-stage rupture diaphragm MB are arranged, according to their thickness, from one edge of the multi-stage rupture diaphragm MB to another edge of the multi-stage rupture diaphragm MB.

The individual stages are activated differently at different pressures in the interior of the degassing device.

For example, S5 can, according to a first embodiment, be activated at the maximum permissible pressure in the interior of the degassing device. S4 can be activated at 97% to 99% of the maximum permissible pressure in the interior of the degassing device.

S3 can be activated at 96% to 98% of the maximum permissible pressure in the interior of the degassing device.

S2 can be activated at 95% to 97% of the maximum permissible pressure in the interior of the degassing device.

S1 can be activated at 94% to 96% of the maximum permissible pressure in the interior of the degassing device.

For example, S5 can, according to a second embodiment, be activated at the maximum permissible pressure in the interior of the degassing device.

S4 can be activated at 90% to 100% of the maximum permissible pressure in the interior of the degassing device.

S3 can be activated at 80% to 90% of the maximum permissible pressure in the interior of the degassing device.

S2 can be activated at 70% to 80% of the maximum permissible pressure in the interior of the degassing device.

S1 can be activated at 60% to 70% of the maximum permissible pressure in the interior of the degassing device.

According to these two embodiments, in the case of a rising pressure in the interior of the degassing device the stage S1 will first be activated and subsequently the stages S2 to S5. This increases the opening through which the substances flow out of the battery system, incrementally, and the flowing out of the substance would be damped. The respectively discharged volume flow of the substances depends on a selection of the size of the stages S1 to S5.

In the partial FIG. 2b the stages S6 to S10 of the multi-stage rupture diaphragm MB are arranged according to their thickness in such a way that the stage S8, which has the smallest thickness, is arranged in the center of the multi-stage rupture diaphragm MB, and the thicknesses of the stages increase toward the edges of the multi-stage rupture diaphragm MB. The arrangement illustrated in the partial FIG. 2b brings about a situation in which the multi-stage rupture diaphragm MB firstly opens in its center and then toward the outside as the pressure increases. The respectively discharged volume flow of the substances depends on a selection of the size of the stages S6 to S10.

In the partial FIG. 2c, the stages S11 to S15 of the multi-stage rupture diaphragm MB are arranged according to their thickness in such a way that the stage S13, which has the greatest thickness, is arranged in the center of the multi-stage rupture diaphragm MB, and the thicknesses of the stages decrease towards the edges of the multi-stage rupture diaphragm MB. The arrangement which is illustrated in the partial FIG. 2c brings about a situation in which the multi-stage rupture diaphragm MB firstly opens toward the outside and then toward the inside as the pressure increases. The respectively discharged volume flow of the substances depends on the selection of the sizes of the stages S11 to S15.

Whether an embodiment according to the partial FIG. 2a, 2b or 2c is to be preferred may depend, for example, on the physical properties of the substance to be discharged.

According to a further embodiment, the stages can also be arranged one after the other in the direction of, or counter to the direction of, the flow vector of the out-flowing substance. Such an arrangement is illustrated in the partial FIG. 2d.

Various stages of the multi-stage rupture diaphragm MB are denoted by S16, S17 and S18. The stages S16 to S18 have various thicknesses and are activated differently at various thicknesses in the interior of the degassing device.

The stages S16 to S18 can be arranged, according to their thickness, in the direction R1 of the flow vector of the out-flowing substance or preferably in the opposite direction R2.

The exemplary thicknesses of the stages S1 to S18 are 0.00005 m and 0.005 m and between these values.

The multi-stage rupture diaphragm MB according to the disclosure is not limited in terms of the number of individual stages to the number of stages which can be seen in partial FIGS. 2a to 2d.

The battery system B according to the disclosure with the multi-stage rupture diaphragm MB can be used, for example, in a vehicle, in particular in a motor vehicle.

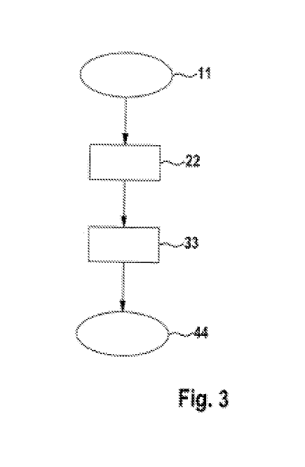

FIG. 3 is a schematic illustration of a method for regulating a volume flow of substances discharged from a battery system. For example an active method is possible by means of the device illustrated schematically in FIG. 1, which device is suitable for performing passive regulation of the volume flow of the discharge substances as a function of the pressure prevailing in the interior of the degassing device EV, as is suitable by means of a throttle, a sound damper, a multi-stage rupture diaphragm or a diaphragm. The active method is started with the method initiation step 11. In the pressure testing step 22 which follows the method initiation step 11, a pressure or a variable representing the pressure in the interior of the degassing device is determined by means of a sensor. In order to determine the pressure or the variable representing the pressure, it is possible to use, for example, a pressure sensor or a temperature sensor.

The pressure or the variable representing the pressure are evaluated with an evaluation unit in the same pressure testing step 22 and the volume flow is set in regulating step 33 as a function of the evaluation. In order to set the volume flow it is possible to use an actuator, particularly a mechanical aperture for regulating the volume flow, driven by a motor, in particular a servo motor.

The method for regulating a volume flow of substances discharged from a battery system is terminated with terminating step 44.

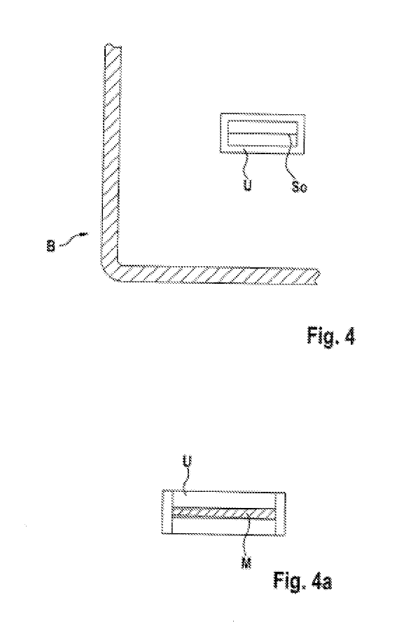

FIG. 4 is a schematic illustration of a battery system according to the disclosure having a diaphragm, wherein the diaphragm is suitable for rupturing under pressure, and the diaphragm has various regions which are at the same level and in parallel in the direction of a flow vector of the discharged substance, and the regions have various thicknesses. The battery system is denoted by B, and an overpressure valve by U. A predetermined break point of the overpressure valve U is denoted by So. The predetermined break point So is suitable for being activated and opened starting from the time when a value of the pressure in the overpressure U is reached or exceeded.

The partial FIG. 4a illustrates schematically the buildup of the overpressure valve U. The diaphragm which is noted by M is inserted into the overpressure valve U. The diaphragm M has various regions, wherein the regions are at the same level and in parallel in the direction of the flow vector of the discharged substance. The regions differ in terms of their thickness.

The battery system B according to the disclosure with the diaphragm M can be used, for example, in a vehicle, in particular in a motor vehicle.

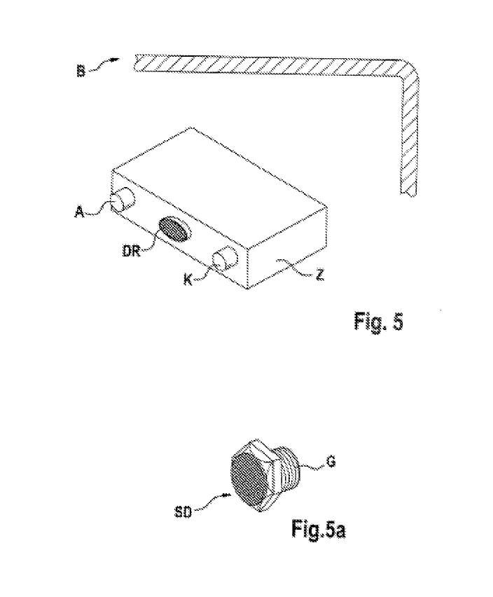

FIG. 5 schematically illustrates a battery system according to the disclosure with a throttle according to a first exemplary embodiment. The battery system is denoted by B, and a battery cell by Z. The battery system B contains at least one battery cell Z. A cathode of the battery cell Z is denoted by K, and an anode of the battery cell Z by A.

A throttle is denoted by DR. The throttle DR is suitable for reducing a flow rate of a substance which flows out of the battery cell Z and is arranged downstream of a degassing device (not illustrated in this figure), in particular downstream of a rupture disk (not illustrated in this figure) or downstream of an overpressure valve (not illustrated in this figure) in the direction of a flow vector of the substance discharged from the battery cell Z.

The partial FIG. 5a schematically illustrates a sound damper; the sound damper is denoted by SD. The sound damper SD is suitable, in particular, for reducing the volume of a noise, wherein the noise is generated by the substance flowing out of the battery cell Z. The sound damper SD can be used in combination with the throttle DR for example, and can be mounted in the direction of the flow vector of the out-flowing substance, for example downstream of the throttle. The sound damper SD can also be used instead of the throttle DR, for example in particular when the sound damper SD produces an effect which is throttling with respect to the flow rate of the out-flowing substance. A thread is denoted by G, said thread being suitable for screwing on the sound damper SD to the degassing device (not illustrated in this figure).

The battery system B according to the disclosure with the throttle DR and/or the sound damper SD can be used, for example, in a vehicle, in particular in a motor vehicle.

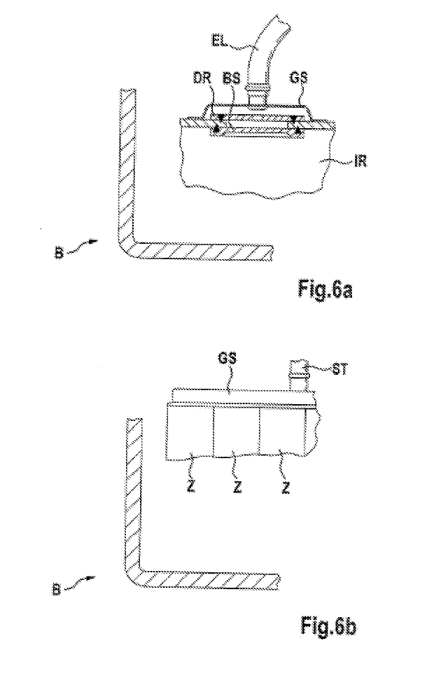

FIG. 6 schematically illustrates a battery system according to the disclosure with a throttle according to a second exemplary embodiment.

In partial FIG. 6a, the battery system is denoted by B. A rupture disk is denoted by BS, and the rupture disk BS is suitable for the controlled discharging of substances from an interior space of the battery system B which is denoted by IR. The rupture disk BS is an exemplary degassing device. A gas collector which is suitable for collecting and storing substances, in particular gases which have escaped from the interior space IR of the battery system B is denoted by GS. A throttle is denoted by DR, and the throttle DR is suitable for reducing a flow rate of a substance flowing out of the interior space IR, and said throttle DR is arranged downstream of the rupture disk BS in the direction of a flow vector of the substance which is discharged from the interior space IR. A degassing line is denoted by EL, said degassing line EL being suitable for discharging substances from the gas collector GS.

In partial FIG. 6b, the battery system is also denoted by B, and a battery cell is denoted by Z. The battery system B contains at least one battery cell Z. A gas collector is also denoted by GS. A connector element is denoted by ST, and the connector element ST is suitable for connecting to the degassing line EL and for discharging substances from the gas collector GS.

The battery system B according to the disclosure with the throttle DR can be used, for example, in a vehicle, in particular in a motor vehicle.

What is claimed is:

1. A battery system, comprising:
at least one degassing device configured to increase safety when using the battery system, the degassing device being configured to control the discharge of substances from the battery system by discharging the substances with a volume flow that is dependent on a pressure prevailing in the interior of the degassing device.

2. The battery system according to claim 1, wherein the at least one degassing device is a rupture disk or an overpressure valve or a degassing line.

3. The battery system according to claim 2, wherein the rupture disk has various regions and the regions have various thicknesses.

4. The battery system according to claim 1, wherein the degassing device has a throttle.

5. The battery system according to claim 1, wherein the degassing device has a sound damper that contains a porous material.

6. The battery system according to claim 1, wherein the degassing device has a multi-stage rupture diaphragm, and wherein the individual rupture diaphragms are activated and penetrated at different pressures in the interior of the degassing device.

7. The battery system according to claim 1, wherein the degassing device has a diaphragm configured to rupture under pressure, the diaphragm having various regions that are located at the same level in parallel in the direction of a flow vector of the discharged substance, the regions having various thicknesses.

8. The battery system according to claim 4, wherein the throttle is arranged downstream of a rupture disk or downstream of an overpressure valve in the direction of a flow vector of the discharged substance.

9. The battery system according to claim 4, wherein the throttle is inserted into a rupture disk or into an overpressure valve.

10. The battery system according to claim 5, wherein the sound damper is arranged downstream of a rupture disk or downstream of an overpressure valve in the direction of a flow vector of the discharged substance.

11. The battery system according claim 5, wherein the sound damper is inserted into a rupture disk or into an overpressure valve.

12. The battery system according to claim 6, wherein the multi-stage rupture diaphragm is arranged downstream of a rupture disk or downstream of an overpressure valve in the direction of a flow vector of the discharged substance.

13. The battery system according to claim 6, wherein the diaphragm is arranged downstream of a rupture disk or downstream of an overpressure valve in the direction of a flow vector of the discharged substance.

14. The battery system according to claim 7, wherein the diaphragm is inserted into a rupture disk or into an overpressure valve.

15. The battery system according to claim 1, wherein a motor vehicle includes the battery system.

16. The battery system according to claim 1, wherein the battery system is configured as a lithium-ion battery system.

17. The battery system according to claim 5, wherein the sound damper contains a sintered metal.

18. The battery system according to claim 5, wherein the sound damper contains a metal mesh or a plastic or a ceramic.
